(19) United States
(12) Patent Application Publication
(10) Pub. No.: US 2024/0348144 A1
(43) Pub. Date: Oct. 17, 2024

(54) ZERO-VOLTAGE AND ZERO-CURRENT SWITCHING CONVERTOR WITH TAPPED INDUCTOR

(71) Applicant: POWER CUBESEMI INC., Seongnam-si (KR)

(72) Inventors: Tai Young KANG, Gwangju-si Gyeonggi-do (KR); Sin Su KYOUNG, Hanam-si (KR); Joon Hyeok JEON, Yongin-si (KR); Lee EUNSOO, Suwon-si (KR); Kim JAEJOON, Anyang-si (KR)

(21) Appl. No.: 18/515,953

(22) Filed: Nov. 21, 2023

(30) Foreign Application Priority Data
Apr. 11, 2023 (KR) 10-2023-0047403

(51) Int. Cl. H02M 1/00; H02M 1/08; H02M 1/34; H02M 3/155

(52) U.S. Cl. CPC H02M 1/0058; H02M 1/083; H02M 1/34; H02M 3/155

(57) ABSTRACT

Tapped inductor boost converter disclosed. The tapped inductor boost converter include a tapped inductor, having a primary winding, a secondary winding, and a tap connected to a contact point of the primary winding and the secondary winding, a switch for connecting or disconnecting a current path between the tap and ground, a switch control circuit for detecting a zero voltage crossing during resonance with a first duty signal and a voltage across the switch, and outputting a second duty signal that turns off the switch, a snubber circuit connected in parallel with the switch, a clamping diode for providing a forward current path from an output terminal of the snubber circuit to an output terminal of the tapped inductor boost converter, an output diode for providing a forward current path from the output terminal of the tapped inductor to the output terminal of the converter output terminal, and a recovery capacitor connected between the output terminal of the tapped inductor and the output terminal of the snubber circuit.

### FIELD OF INVENTION

The present invention relates to zero-voltage and zero-current switching boost converter.

### RELATED ART

Solar power generation is a power generation system that produces electricity using solar energy. PV modules composed of multiple solar cells generate direct current power. Regarding switching loss, which is a loss occurring in power conversion, the prior art requires multiple switches to apply to 10 KW applications and secure efficiency, which results in large switching loss. Conversely, if the number of switches is reduced to reduce switching losses, it is difficult to achieve efficiency.

### SUMMARY

The present invention is intended to provide a boost converter that can minimize switching losses.

According to one aspect of the present invention, there is provided a tapped inductor boost converter including a tapped inductor, having a primary winding, one end of which is connected to an input power source, a secondary winding connected between the other end of the primary winding and an output terminal of the tapped inductor, and a tap connected to a contact point of the primary winding and the secondary winding, a switch, configured for connecting or disconnecting a current path between the tap and ground, a switch control circuit, configured for detecting a zero voltage crossing during resonance with a first duty signal and a voltage across the switch, and outputting a second duty signal that turns off the switch, a snubber circuit connected in parallel with the switch, a clamping diode, configured for providing a forward current path from an output terminal of the snubber circuit to an output terminal of the tapped inductor boost converter, an output diode, configured for providing a forward current path from the output terminal of the tapped inductor to the output terminal of the converter output terminal, and a recovery capacitor connected between the output terminal of the tapped inductor and the output terminal of the snubber circuit.

In one embodiment, the resonance occurs when the switch is turned on, and when the first duty signal is turned off during the resonance, the switch control circuit outputs the second duty signal that is turned off at the zero voltage crossing.

In one embodiment, the switch control circuit includes an AND gate, configured for receiving an inverted voltage across the switch and an inverted first duty signal, and a latch having a RESET terminal connected to an output terminal of the AND gate and a SET terminal that receives the first duty signal.

In one embodiment, the snubber circuit includes a snubber diode, configured for providing a forward current path from the tap to the output terminal of the snubber circuit, and a snubber capacitor connected in series to the snubber diode.

In one embodiment, a turn ratio of the tapped inductor is 5, and a capacitance ratio between the snubber capacitor and the recovery capacitor is 1.

In one embodiment, the tapped inductor boost converter performs zero current switching when the switch is turned on and zero voltage switching when the switch is turned off.

The tapped inductor boost converter according to an embodiment of the present invention can reduce costs by using fewer elements than other topologies in boost converters applied to existing 10 kW solar applications, and additionally improves power efficiency, making it possible to reduce costs compared to other boost converter topologies. There is a greater economic advantage.

### BRIEF DESCRIPTION OF ACCOMPANYING DRAWINGS

FIG. 1 exemplarily illustrates a tapped inductor boost converter;

FIG. 2 and FIG. 3 exemplarily illustrate a switching operation of the tapped inductor boost converter;

FIG. 4 exemplarily illustrates waveforms according to the switching operation of the tapped inductor boost converter;

FIG. 5 exemplarily illustrates a switch control circuit that controls the tapped inductor boost converter to turn off ZVC;

FIG. 6 is a flowchart illustrating the design process of a tapped inductor boost converter;

FIG. 7A, FIG. 7B, FIG. 7C and FIG. 7D are graphs showing the change in breakdown voltage according to changes in n and ac; and

FIG. 8A, FIG. 8B, FIG. 8C and FIG. 8D are graphs showing the change in the minimum voltage crossing of the snubber capacitor according to changes in α_{c}.

### DESCRIPTION OF EMBODIMENTS

The invention can be modified in various forms and specific embodiments will be described and shown below. However, the embodiments are not intended to limit the invention, but it should be understood that the invention includes all the modifications, equivalents, and replacements belonging to the concept and the technical scope of the invention. In describing the present invention, if it is determined that a detailed description of a related known technology may obscure the gist of the present invention, the detailed description thereof will be omitted.

Terms such as first, second, etc., may be used to refer to various elements, but, these elements should not be limited due to these terms. These terms will be used to distinguish one element from another element.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

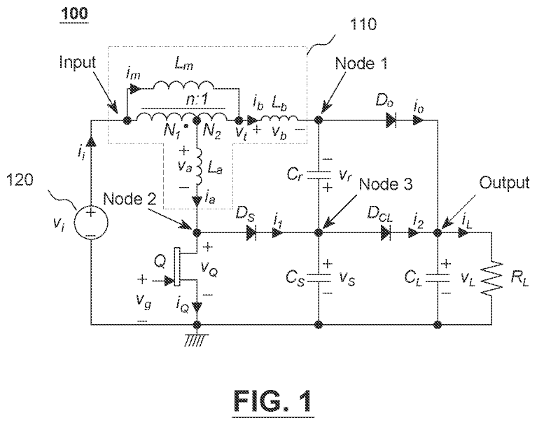

FIG. 1 exemplarily illustrates a tapped inductor boost converter.

Referring to FIG. 1, the tapped inductor boost converter 100 may include a tapped inductor 110, a switch Q, a snubber diode D_{S}, a snubber capacitor C_{S}, a clamp diode D_{CL}, a recovery capacitor Cᵣ, an output diode D_{O}, a load capacitor C_{L}, a load, and a resistance R_{L}. The snubber diode D_{S}, the clamp diode D_{CL}, and the output diode D_{O} are fast recovery diodes, and their switching losses, conduction losses, and reverse recovery switching times are small.

An input terminal of the tap inductor 110 is connected to the input power source 120, an output terminal is connected to the first node, and a tap is connected to the second node. In detail, the tap inductor 110 may include a primary winding with one end connected to the input power source 120, a secondary winding connected between the other end of the primary winding and the first node, and the tap connected to a contact point between the primary winding and the secondary winding. One end of the input power source 120 is connected to the input terminal of the tap inductor 110, and the other end is connected to ground.

The tap is connected to the second node. As illustrated in FIG. 1, the tap inductor 110 can be modeled as an ideal autotransformer having a large magnetizing inductance Lₘ, two small leakage inductances Lₐ and L_{b}, and a turns ratio of n:1 (n=N1/N2). The tap inductor 110 can limit a current slope during zero current switching (ZCS) with leakage inductances Lₐ and L_{b}.

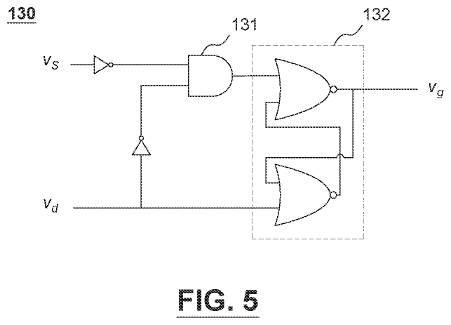

The switch Q is connected between the second node and ground, and connects or disconnects a current path between the second node and ground by the second duty signal applied by a switch control circuit 130 (see FIG. 5). At the second node, a drain of the switch Q and the snubber diode D_{S} are electrically connected to the tap, and a source of the switch Q is connected to ground. The switch Q may be a power semiconductor capable of high-speed switching, for example, SiC MOSFET, SJ MOSFET, and so on. The Switch Q adjusts an output voltage and power based on a current flowing from the input power source 120 to the tap inductor 110.

The snubber diode D_{S} provides a forward current path from the second node to the third node, and the snubber capacitor C_{S} is connected to the third node and ground. The third node is an output terminal of a snubber circuit consisting of the snubber diode D_{S} and the snubber capacitor C_{S}. That is, the snubber circuit is connected in parallel with the switch Q.

The clamp diode D_{CL} provides a forward current path from the third node to an output terminal of the converter 100. The load resistor R_{L} and the load capacitor C_{L} are connected in parallel between the output terminal of the converter 100 and ground.

The recovery capacitor Cᵣ is connected between the first node and the third node.

The output diode D_{O} provides a forward current path from the first node to the output terminal of the converter 100.

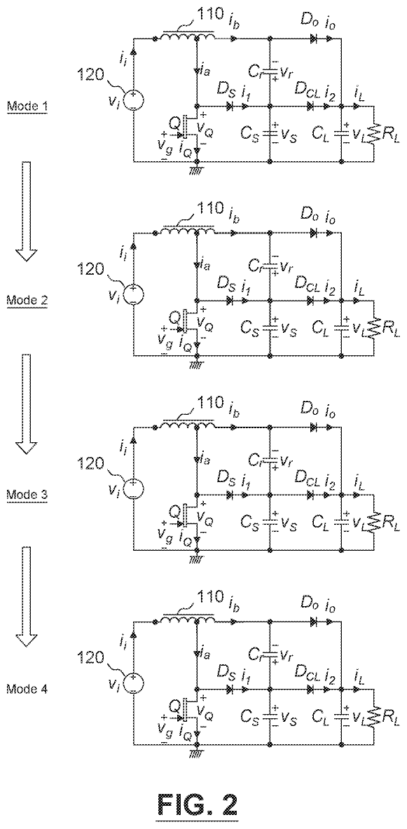

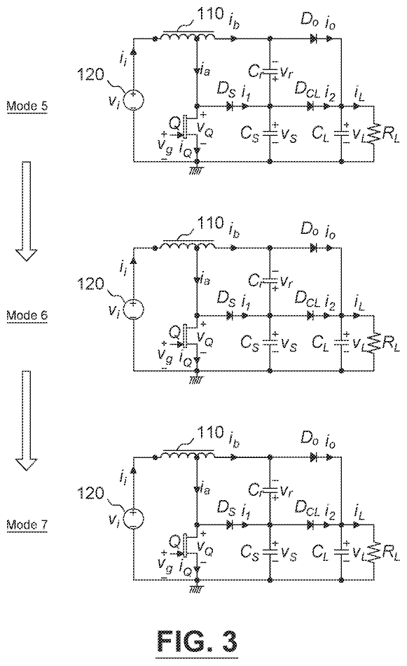

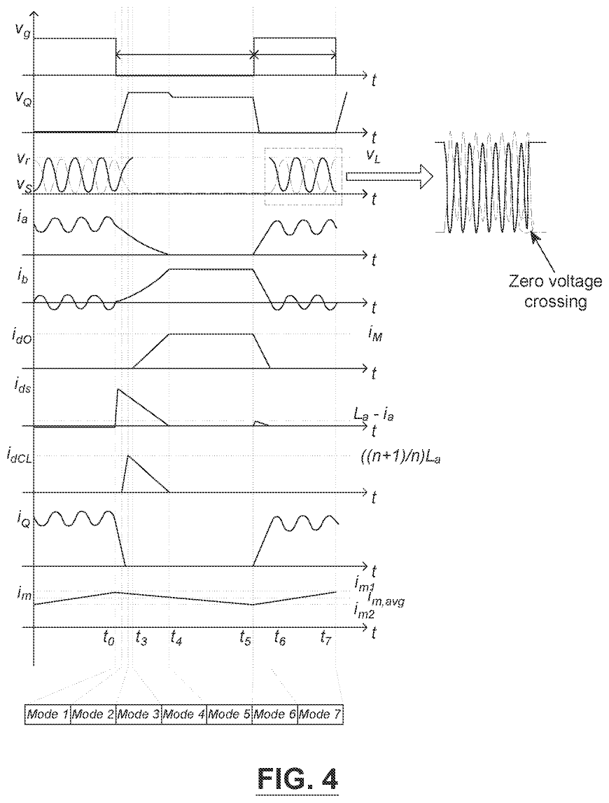

FIG. 2 and FIG. 3 exemplarily illustrate a switching operation of the tapped inductor boost converter, and FIG. 4 exemplarily illustrates waveforms according to the switching operation of the tapped inductor boost converter.

Referring to FIGS. 2 to 4 together, the switching operation of the tapped inductor boost converter 100 may be divided into the first to the seventh modes. The switch Q is turned off in the first to fifth modes, and turned on in the sixth and seventh modes.

In the first mode, when the switch Q is turned off at time t0, the snubber capacitor C_{S} is charged by the voltage of the input power supply 120, and a rising slope of a voltage v_{S} across the snubber capacitor C_{S} decreases. Through this, turn-off ZVS (Zero voltage switching) becomes possible. The first mode continues until a current i₂ flows through the clamp diode D_{CL}.

In the second mode, the recovery capacitor Cᵣ begins to discharge until the snubber capacitor C_{S} is fully charged.

In the third mode, the snubber capacitor C_{S} is fully charged, so the current i₂ becomes the sum of a current in and a current from the recovery capacitor Cᵣ. The third mode continues until the recovery capacitor Cᵣ is completely discharged.

In the fourth mode, when the recovery capacitor Cᵣ is completely discharged, a current iₐ from the tap is output to the output terminal of the converter 100 through the snubber diode D_{S} and the clamp diode D_{CL}, and a current i_{b} from the output terminal of the tap inductor 110 is output to the output terminal of the converter 100 through the output diode D_{O}. In the fourth mode, the current iₐ is a residual current due to the leakage inductance Lₐ of the tap inductor 110, and the current i_{b} is a residual current due to the leakage inductance L_{b}. The fourth mode continues until the current iₐ becomes 0.

In the fifth mode, a current due to the magnetizing inductance Lₘ operating in CCM (Continuous Current Mode) is output to the output terminal of the converter 100 through the output diode D_{O}. The fifth mode continues until switch Q is turned on.

In the sixth mode, when the switch Q is turned on, the current i_{b} due to the leakage inductance L_{b} of the tap inductor 110 reduces the rising slope of a current i_{Q}. Through this, turn-on ZCS becomes possible. The sixth mode continues until all residual charges in the output diode D_{O} are discharged.

In the seventh mode, after all residual current due to leakage inductance flows to the load, a resonance occurs in the tapped inductor boost converter 100. When operating in the seventh mode, a resonance loop composed of the leakage inductances Lₐ and L_{b}, the snubber capacitor C_{S}, the recovery capacitor Cᵣ, the switch Q, the input power source 120, and the tap inductor 110 is formed in the tapped inductor boost converter 100. When the resonance occurs, the voltage vₛ increases and decreases repeatedly between substantially 0 and vᵣ(V). Therefore, when the voltage v_{S} applied across the switch Q reaches a ZVC (zero voltage crossing), a switching loss can be minimized by turning off the switch Q (hereinafter referred to as ZVC turn off).

FIG. 5 exemplarily illustrates a switch control circuit that controls the tapped inductor boost converter to turn off ZVC.

Referring to FIG. 5, the switch control circuit 130 outputs the second duty signal v_{g} applied to the switch Q using the first duty signal v_{d} output from a converter driver (not shown) and the voltage v_{S} across the snubber capacitor Cₛ. The second duty signal v_{g} is turn off (i.e., logically low) when the voltage v_{S} reaches ZVC after the first duty signal v_{d} is turned on (i.e., logically on) while the tapped inductor boost converter 100 is operating in the seventh mode.

For this purpose, the switch control circuit 130 may include an AND gate 131 that receives the inverted voltage v_{S} and an inverted first duty signal v_{d}, and a latch 132 having a RESET terminal connected to an output terminal of the AND gate 131 and a SET terminal connected to the first duty signal v_{d}. While operating in the seventh mode, the switch control circuit 130 outputs the second duty signal v_{g} that is substantially the same as the first duty signal va in the first to sixth modes, and outputs the second duty signal v_{g} when detecting that the first duty signal v_{d} goes off and then detecting ZVC of the voltage v_{S}.

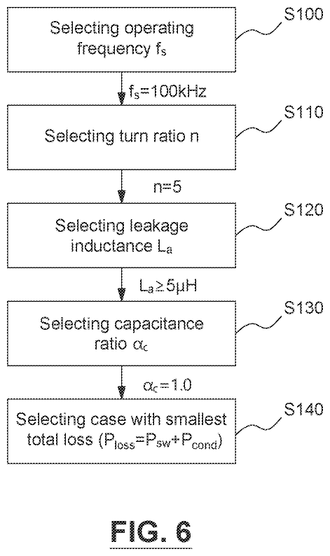

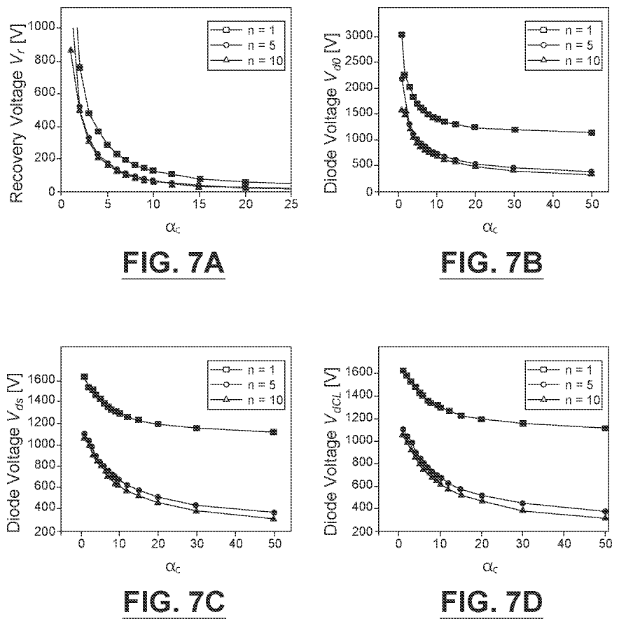

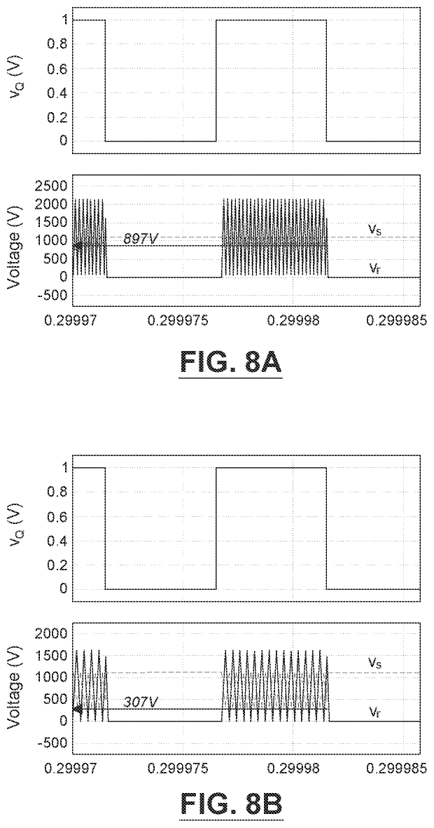

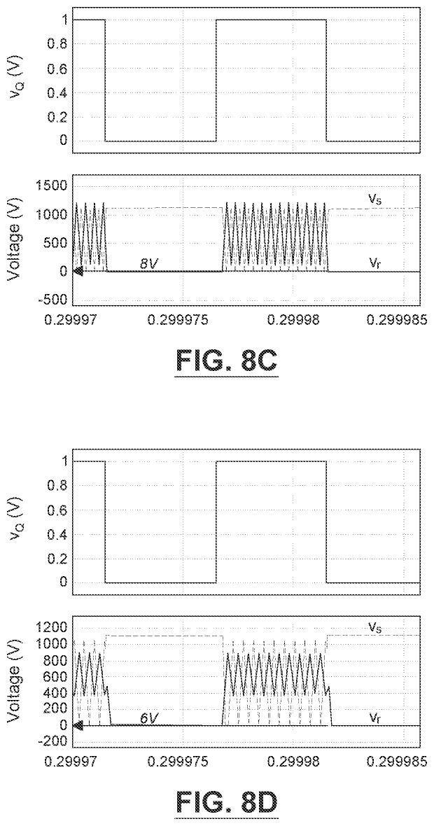

FIG. 6 is a flowchart illustrating the design process of a tapped inductor boost converter, FIG. 7A, FIG. 7B, FIG. 7C and FIG. 7D are graphs showing the change in breakdown voltage according to changes in n and α_{c}, and FIG. 8A, FIG. 8B, FIG. 8C and FIG. 8D are graphs showing the change in the minimum voltage crossing of the snubber capacitor according to changes in α_{c}.

Referring to FIG. 6, a design process is for optimally determining each parameter defining the converter 100 in operation.

The design process of the tap inductor boost converter 100 may consist of selecting an operating frequency fₛ, and then selecting main parameters of the converter 100, namely, the first leakage inductance Lₐ, the second leakage inductance L_{b}, the snubber capacitance Cₛ, the recovery capacitance Cᵣ, and the turn ratio n of the tap inductor 110.

In S100, the operating frequency f_{S} may be selected to be about 100 kHz considering the characteristics of the SIC MOSFET used as switch Q.

In S110, the turn ratio n may be selected. The turn ratio n is a ratio of the inductor windings that determines the first leakage inductance Lₐ and the second leakage inductance L_{b} of the tap inductor 110. The turn ratio n may be selected in consideration of the voltage vᵣ across the recovery capacitor Cᵣ, the voltage VDS across the snubber diode D_{S}, the voltage V_{DCL} across the clamping diode D_{CL}, and the voltage V_{DO} across the output diode D_{O}. Increasing the turn ratio n has an advantage in its breakdown voltage.

Referring to FIG. 7A through FIG. 7D are graphs showing the change in breakdown voltage according to changes in n and α_{c}, the turn ratio n is gradually increased to show the measured values of the voltage vᵣ of the recovery capacitor Cᵣ and voltages across each diode. The increase in turn ratio n and the magnitude of the voltages applied to the recovery capacitor Cᵣ and each diode are inversely proportional. An increase in the voltage applied to the recovery capacitor Cᵣ and each diode may result in a decrease in power efficiency and power density due to an increase in device size and an increase in voltage stress caused by an increase in breakdown voltage. Therefore, as shown, considering the power density and efficiency due to the increase in turns ratio n, the saturated turn ratio n can be selected as 5. α_{c} selected as the X-axis is a ratio of the snubber capacitance Cₛ and the recovery capacitance Cᵣ. α_{c} is used to select the capacitance of S130, and the snubber capacitance Cₛ is assumed to be approximately 1 nF.

Referring again to FIG. 6, in S120, the first leakage inductance Lₐ and the second leakage inductance L_{b} may be selected. A ratio of the first leakage inductance Lₐ and the second leakage inductance L_{b} may be automatically determined once the turn ratio n is selected in S110, according to the principle that a ratio of inductance is proportional to the square of the number of turns. The design process is carried out based on the first leakage inductance La. The first leakage inductance Lₐ and the second leakage inductance L_{b} are set as the minimum conditions for the leakage inductance through Equation 1 considering a duty resolution above a certain value of the resonance frequency fᵣ in the resonance loop occurring in the seventh mode. A period T of the resonance frequency fᵣ can be selected as a value less than 0.05 of a period T_{S} of the operating frequency fₛ. An upper limit of the first leakage inductance Lₐ is selected through Equation 1, and Equation 1 may lead to Equation 2 that can comprehensively consider inductance, capacitance, and turn ratio by including the selection process of the snubber capacitance Cₛ and the recovery capacitance Cᵣ.

$$\frac{1}{{f}_{r}} = {T}_{r} = 2 π \sqrt{\{ {( \frac{n + 1}{n} )}^{2} {L}_{a} + {L}_{b} \} ( {C}_{r} // {C}_{s} )} < \frac{{T}_{s}}{20} ( {C}_{r} // {C}_{s} = \frac{{C}_{r} {C}_{s}}{{C}_{r} + {C}_{s}} {L}_{a} * \frac{{L}_{b}}{{n}^{2}} ) - {( \frac{{T}_{s}}{40 π} )}^{2} ( \frac{1}{{C}_{s}} + \frac{1}{{C}_{r}} ) ( \frac{n}{{n}^{2} + 2 n + 2} ) > {L}_{a} \qquad ( Equation 1 )$$

In S130, in the process of selecting the snubber capacitance Cₛ and the recovery capacitance Cᵣ, whether ZVC of the voltage v_{S} across the snubber capacitor C_{S} for the operation of the switch control circuit 130 is reached is determined by the change in α_{c} with reference to FIGS. 8A through 8D. The snubber capacitance C_{S} is selected as 1 nF as the initial condition. In FIGS. 8A through 8D, measurements were made while increasing α_{c} to find ZVC for operating the switch control circuit 130. FIG. 8A shows v_{S} when α_{c}=0.1, FIG. 8B shows v_{S} when α_{c}=0.5, FIG. 8C shows v_{S} when α_{c}=1.0, and FIG. 8D shows v_{S} when α_{c}=2.0. When α_{c}=1.0 and α_{c}=2.0, ZVC switching was detected at 8 V and 6 V instead of 0 V, but this is because the switching was made after discharging more than 99 percent of the charge in the snubber capacitor C_{S}, therefore these can be also considered as ZVC switching. α_{c} was selected as 1.0 to maximize the increase in power density.

In S130, a case with the smallest total loss may be selected based on the resonant frequency. Equation 2 expresses the resonance frequency fᵣ in the seventh mode. By substituting the operating frequency f_{S} selected in S100, the turn ratio n selected in S110, the ratio and conditions of the first leakage inductance Lₐ and the second leakage inductance L_{b} selected in S120, and the ratio α_{c} of the snubber capacitance Cₛ and the recovery capacitance Cᵣ selected in S130 into Equation 2, parameter values for implementing the smallest switching loss can be obtained among the parameter values that satisfy Equation 2.

$$ω = \frac{1}{\sqrt{\{ {( \frac{n + 1}{n} )}^{2} {L}_{a} + {L}_{b} \} ( {C}_{r} // {C}_{s} )}} \qquad ( Equation 2 )$$

By selecting parameter values that satisfy Equation 2 according to the conditions selected in S100 to S130, the parameter values for the lowest switching loss can be selected. The total loss Pₗₒₛₛ=P_{sw} (switching loss)+P_{cond} (conduction loss) when applying the example of possible cases is shown in Table below.

| Parameter | Case1 | | Case2 | | Case3 | | Case4 | | Case5 | |
|---|---|---|---|---|---|---|---|---|---|---|
| n | 5 | | 5 | | 5 | | 5 | | 5 | |
| Lₐ | 5 | μH | 4.5 | μH | 4 | μH | 3.5 | μH | 3 | μH |
| L_{b} | 1 | μH | 0.9 | μH | 0.8 | μH | 0.7 | μH | 0.6 | μH |
| Cₛ | 1.5 | nF | 1.7 | nF | 1.9 | nF | 2.2 | nF | 2.5 | nF |
| Cᵣ | 1.5 | nF | 1.7 | nF | 1.9 | nF | 2.2 | nF | 2.5 | nF |
| Pₗₒₛₛ = P_{sw} + P_{cond} | 0.0813 | W | 0.1011 | W | 0.1023 | W | 0.1040 | W | 0.1058 | W |

In Table, the first leakage inductance Lₐ=5 μH is the highest among the values selected in S120, and as the first leakage inductance Lₐ decreases, the total loss value increases, so Case 1 is finally adopted.

The above description of the invention is exemplary, and those skilled in the art can understand that the invention can be modified in other forms without changing the technical concept or the essential feature of the invention. Therefore, it should be understood that the above-mentioned embodiments are exemplary in all respects, but are not definitive.

The scope of the invention is defined by the appended claims, not by the above detailed description, and it should be construed that all changes or modifications derived from the meanings and scope of the claims and equivalent concepts thereof are included in the scope of the invention.

What is claimed is:

1. A tapped inductor boost converter, comprising:
a tapped inductor, having a primary winding, one end of which is connected to an input power source, a secondary winding connected between the other end of the primary winding and an output terminal of the tapped inductor, and a tap connected to a contact point of the primary winding and the secondary winding;
a switch, configured for connecting or disconnecting a current path between the tap and ground;
a switch control circuit, configured for detecting a zero voltage crossing during resonance with a first duty signal and a voltage across the switch, and outputting a second duty signal that turns off the switch;
a snubber circuit connected in parallel with the switch;
a clamping diode, configured for providing a forward current path from an output terminal of the snubber circuit to an output terminal of the tapped inductor boost converter;
an output diode, configured for providing a forward current path from the output terminal of the tapped inductor to the output terminal of the converter output terminal; and
a recovery capacitor connected between the output terminal of the tapped inductor and the output terminal of the snubber circuit.

2. The tapped inductor boost converter of claim 1, wherein the resonance occurs when the switch is turned on,
wherein when the first duty signal is turned off during the resonance, the switch control circuit outputs the second duty signal that is turned off at the zero voltage crossing.

3. The tapped inductor boost converter of claim 1, wherein the switch control circuit comprises:
an AND gate, configured for receiving an inverted voltage across the snubber capacitor and an inverted first duty signal; and
a latch having a RESET terminal connected to an output terminal of the AND gate and a SET terminal that receives the first duty signal.

4. The tapped inductor boost converter of claim 1, wherein the snubber circuit comprises:
a snubber diode, configured for providing a forward current path from the tap to the output terminal of the snubber circuit; and
a snubber capacitor connected in series to the snubber diode.

5. The tapped inductor boost converter of claim 4, wherein a turn ratio of the tapped inductor is 5,
wherein a capacitance ratio between the snubber capacitor and the recovery capacitor is 1.

6. The tapped inductor boost converter of claim 4, wherein the tapped inductor boost converter performs zero current switching when the switch is turned on and zero voltage switching when the switch is turned off.
